(19) United States
(12) Patent Application Publication
(10) Pub. No.: US 2026/0309646 A1
(43) Pub. Date: Oct. 8, 2026

(54) WORKPIECE VISUAL INSPECTION APPARATUS AND METHOD

(71) Applicant: TOKYO SEIMITSU CO., LTD, Hachioji-shi, Tokyo (JP)

(72) Inventor: Yuki MAEDA, Hachioji-shi, Tokyo (JP)

(21) Appl. No.: 19/164,316

(22) PCT Filed: Mar. 21, 2024
(86) PCT No.: PCT/JP2024/011004

§ 371 Date: Sep. 11, 2025

(30) Foreign Application Priority Data
Mar. 23, 2023 (JP) 2023046816

(51) Int. Cl. G01N 21/956; G01N 21/88

(52) U.S. Cl. CPC G01N 21/956; G01N 21/8851; G01N 2201/104

(57) ABSTRACT

A workpiece visual inspection apparatus 1 includes a chuck table 2 on which a workpiece W is placed, cameras 4A, 4B, and 4C that image a processed surface Wa of the workpiece W, a first slide mechanism 23 and a second slide mechanism 44 that move at least one of the chuck table 2 and the cameras 4A, 4B, and 4C relative to the other, to scan respective imaging positions 4a, 4b, and 4c of the cameras 4A, 4B, and 4C in a rectangular shape as viewed from the top, and a determination unit 52 that determines a quality of the workpiece W on the basis of a plurality of captured images obtained by imaging with the cameras 4A, 4B, and 4C.

### TECHNICAL FIELD

The present invention relates to a workpiece visual inspection apparatus and method for determining the quality of a workpiece after grinding or polishing.

### BACKGROUND ART

Workpiece visual inspection to be performed after grinding or polishing a back surface of a semiconductor silicon wafer or the like (hereinafter referred to as a “workpiece”) is used to confirm the presence or absence of a scratch, a crack, a fine particle, a surface burn, an abnormal streak, or the like on a processed surface of the workpiece.

Patent Literature 1 discloses a wafer inspection apparatus that includes a macro camera and a micro camera respectively having different fields of view (imaging ranges) and magnifications and recognizes the coordinates of each of at least three points of the outer circumference a wafer from a captured image obtained by imaging with the macro camera, calculates the center coordinates of the wafer from the coordinates of the three points and scans the micro camera in an X-axis direction such that the imaging range of the micro camera follows a position of the outer circumference of the wafer in consideration of a distance between the center coordinates of a holding table and the center coordinates of the wafer.

Patent Literature 2 discloses an inspection apparatus that positions an imaging unit of a line sensor at the center of a holding table and directly above a wafer and then moves the line sensor at a constant speed from the center side toward the outer side of the holding table while rotating the holding table so that the whole of a grinded surface of the wafer is imaged in a spiral shape.

### CITATION LIST

### Patent Literature

Patent Literature 1: Japanese Patent Laid-Open No. 2021-15850
Patent Literature 2: Japanese Patent Laid-Open No. 2019-32260

### SUMMARY OF INVENTION

### Technical Problem

However, in the wafer inspection apparatus described in Patent Literature 1, when it is necessary to calculate the center coordinates of the wafer from a captured image of a wafer surface imaged with the macro camera prior to imaging of the outer circumference of the wafer with the micro camera, an unnecessary range other than the outer circumference of the wafer is imaged for convenience of imaging the wafer surface while scanning the macro camera in the X-axis direction. Accordingly, there has been a problem that a throughput deteriorates.

In the inspection apparatus described in Patent Literature 2, a peripheral speed is increased and an exposure time period is shortened from the center side toward the outer side of the wafer. Accordingly, a captured image obtained by imaging with the imaging unit tends to be gradually darkened from the center side toward the outer side of the wafer, which may interfere with detection of a surface burn, a grinding streak, or the like particularly in visual inspection using a dark captured image. When the wafer is imaged in a spiral shape, complicated image processing such as a polar coordinate transformation needs to be performed when a plurality of images are combined into a single inspection image, which may cause a throughput to deteriorate. Further, in visual inspection of a so-called dicing-before-grinding wafer in which a lattice-shaped groove is formed along a fracture planned line on the wafer, the groove is generally subjected to mask processing such that the groove is not erroneously detected as a crack, a scratch, or the like. However, there has been a problem that it is practically difficult to accurately subject a lattice-shaped groove that appears on an inspection image formed by combining a plurality of captured images obtained by imaging in a spiral shape to mask processing.

Therefore, there occurs a technical problem to be solved to accurately and efficiently perform visual inspection of a workpiece, and the present invention has as its object to solve this problem.

### Solution to Problem

To attain the above-described object, a workpiece visual inspection apparatus according to the present invention is a workpiece visual inspection apparatus that determines a quality of a workpiece after back surface processing, the workpiece visual inspection apparatus including a chuck table on which the workpiece is placed, an imaging unit that images a processed surface of the workpiece, a driving mechanism that moves at least one of the chuck table and the imaging unit relative to the other, to scan the imaging unit in a rectangular shape as viewed from the top, and a determination unit that determines the quality of the workpiece on the basis of a plurality of captured images obtained by the imaging with the imaging unit.

A workpiece visual inspection method according to the present invention is a workpiece visual inspection method for determining a quality of a workpiece after back surface processing, the workpiece visual inspection method including the steps of placing the workpiece on a chuck table, moving at least one of the chuck table and an imaging unit relative to the other, to scan the imaging unit in a rectangular shape as viewed from the top so that the imaging unit images a processed surface of the workpiece, and determining the quality of the workpiece on the basis of a plurality of captured images obtained by the imaging with the imaging unit.

### Advantageous Effect of the Invention

According to the present invention, visual inspection of a workpiece can be accurately and efficiently performed.

### BRIEF DESCRIPTION OF DRAWINGS

FIG. 1 is a perspective view schematically illustrating a workpiece visual inspection apparatus according to one embodiment of the present invention.

FIG. 2 is a plan view illustrating a positional relationship of an imaging position of a camera with respect to a chuck table and a workpiece.

FIG. 3 is a diagram illustrating a captured image obtained by imaging with the camera.

FIG. 4 is a schematic view illustrating an edge trend line related to an edge position of the workpiece generated from the captured image illustrated in FIG. 3.

FIG. 5 is a plan view illustrating a relative positional relationship between the chuck table and the workpiece.

FIG. 6 is a schematic view illustrating a principal part of FIG. 5.

FIG. 7 is a plan view illustrating a scanning trajectory of the camera relative to the workpiece.

### DESCRIPTION OF EMBODIMENT

One embodiment of the present invention will be described with reference to the drawings. Hereinafter, when reference is made to the number, numerical value, amount, range, or the like of each components, the number or the like is not limited to a specific number but may be the specific number or more or the specific number or less unless otherwise stated or except when apparently limited to the specific number in principle.

When reference is made to a shape of each components and a positional relationship among the components, a substantially approximate or similar shape or the like is included unless otherwise stated or except when considered to be apparently excluded in principle.

In the drawings, characteristic portions may be exaggerated by being enlarged, for example, in order to facilitate the understanding of features, and a dimension ratio or the like of each of components is not necessarily the same as an actual one. In a cross-sectional view, hatching of some of the components may be omitted in order to facilitate the understanding of a cross-sectional structure of the components.

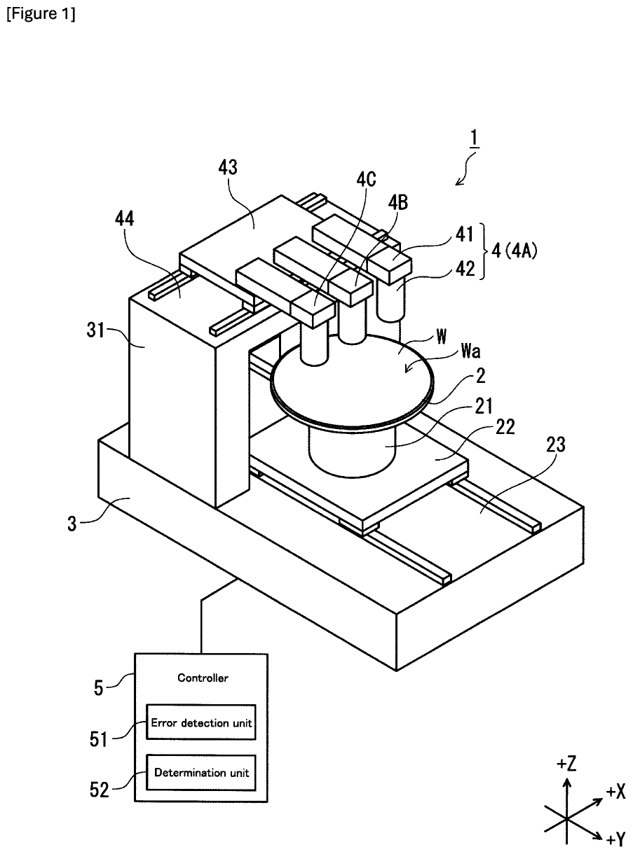

FIG. 1 is a perspective view schematically illustrating a workpiece visual inspection apparatus 1 according to one embodiment of the present invention. The workpiece visual inspection apparatus 1 performs visual inspection of a workpiece W after back surface grinding. The workpiece W is, for example, a silicon wafer, but is not limited to this. The workpiece visual inspection apparatus 1 includes a chuck table 2, a base 3, and a camera 4.

The chuck table 2 is configured to be able to hold the workpiece W on its upper surface (suction surface). The suction surface of the chuck table 2 is connected to a vacuum source or a compressed air source not illustrated. When the vacuum source is activated, the workpiece W placed on the suction surface is sucked and held on the suction surface. When the compressed air source is activated, suction between the workpiece W and the suction surface is released.

The chuck table 2 is configured to be rotatable around a rotation axis passing through a rotation center of the chuck table 2 and parallel to a Z-axis by a chuck spindle 21. The chuck spindle 21 is placed on a chuck stage 22. The chuck stage 22 is provided on the base 3 through a first slide mechanism 23 that is slidable relative to the base 3 in a Y-axis direction. The first slide mechanism 23 is, for example, a ball screw actuator.

On an upper surface of the base 3, a column 31 is provided to stride over the chuck table 2 and the first slide mechanism 23.

The camera 4 includes three cameras 4 provided in an X-axis direction. The number of cameras 4 is not limited to three, but may be two or less or four or more. The camera 4 includes a line scan camera 41 and a collimator lens 42 connected to the line scan camera 41. The camera 4 also includes illumination not illustrated that illuminates an imaging position of the line scan camera 41. The illumination forms coaxial epi-illumination in which an optical axis of illumination light of the illumination and an optical axis of the collimator lens 42 substantially match each other via a beam splitter not illustrated. Illumination light used when the camera 4 images the workpiece W is not limited to coaxial epi-illumination, but may be, for example, side illumination.

An end of the line scan camera 41 is supported in a cantilevered manner on a camera stage 43. The camera stage 43 is provided on the column 31 through a second slide mechanism 44 that is slidable relative to the column 31 in the X-axis direction. The second slide mechanism 44 is, for example, a ball screw actuator. When the second slide mechanism 44 is driven, a position of the camera 4 relative to the chuck table 2 can be adjusted.

The line scan camera 41 receives an encoder signal which is linked with a motor of the chuck spindle 21 as a line trigger. The line scan camera 41 can image a processed surface Wa of the workpiece W over a period during which the chuck table 2 rotates once on the basis of the encoder signal of the chuck spindle 21.

An operation of the workpiece visual inspection apparatus 1 is controlled by a controller 5. The controller 5 controls each of components constituting the workpiece visual inspection apparatus 1. The controller 5 is, for example, a computer, and is constituted by a CPU, a memory, and the like. A function of the controller 5 may be implemented by control using software, or may be implemented by one that operates using hardware.

The controller 5 includes an error detection unit 51 and a determination unit 52.

The error detection unit 51 detects a positional relationship (placement error) of the center of the workpiece W relative to the rotation center of the chuck table 2 on the basis of a captured image obtained by imaging with the line scan camera 41.

The determination unit 52 determines the quality of the workpiece W on the basis of the captured image obtained by the imaging with the camera 4.

Then, a procedure for visual inspection using the workpiece visual inspection apparatus 1 will be described. In the following description, when the three cameras 4, the three line scan cameras 41, or the like are distinguished, “A”, “B”, and “C” are respectively added to the ends of their reference numerals.

### <Workpiece Chuck>

A transfer robot or the like not illustrated delivers the workpiece W to the chuck table 2, and the chuck table 2 sucks and holds the workpiece W placed on the suction surface.

### <Alignment>

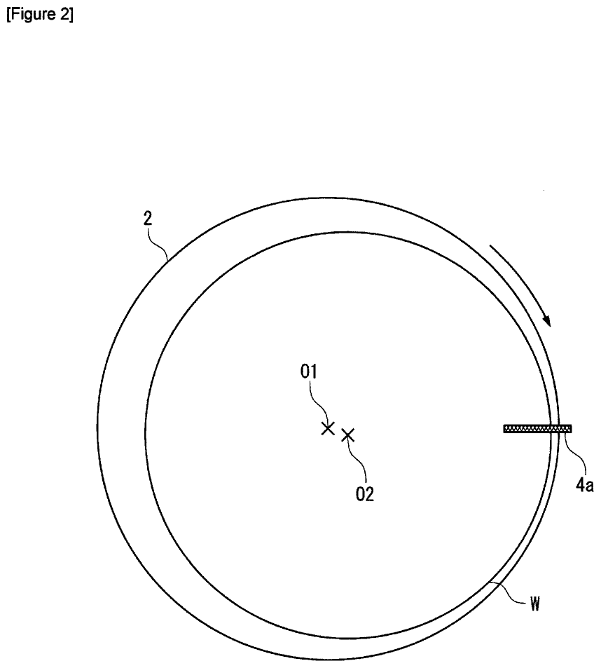

As illustrated in FIG. 2, a rotation center 01 of the chuck table 2 and a center 02 of the workpiece W may not match each other depending on the positioning accuracy of the transfer robot. Accordingly, a placement error of the workpiece W relative to the chuck table 2 is detected prior to the visual inspection of the workpiece W.

First, the first slide mechanism 23 and the second slide mechanism 44 are driven, so that an imaging position 4a of the camera 4A is set to include at least respective edges of the chuck table 2 and the workpiece W, as illustrated in FIG. 2. The size of the imaging position 4a is set to, for example, about 2 μm×about 20 mm.

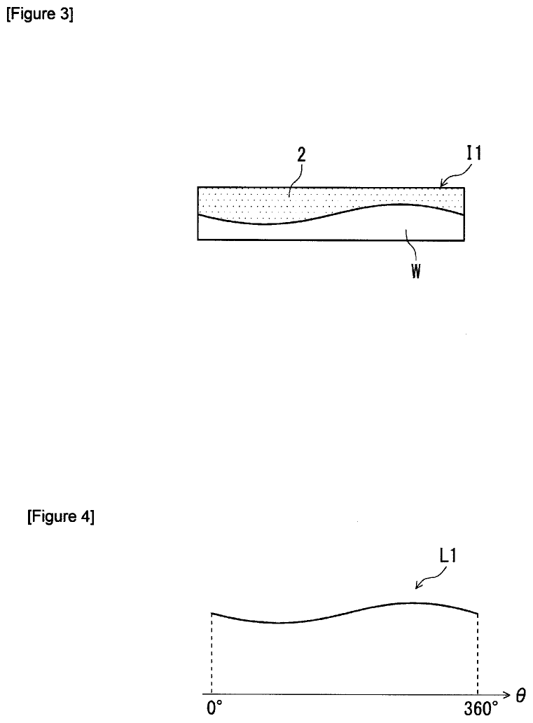

Then, the camera 4A images the edge of the workpiece W with the chuck table 2 and the workpiece W rotated. FIG. 3 illustrates an example of a captured image I1 that reflects the entire circumference of the edge of the workpiece W imaged with the line scan camera 41. In the captured image I1, the workpiece W appears bright by reflection of illumination light, and the chuck table 2 appears relatively dark. Accordingly, a light/dark boundary in the captured image I1 corresponds to the edge of the workpiece W.

Then, the error detection unit 51 detects an edge position over the entire circumference of the workpiece W from the captured image I1, thereby generating an edge trend line L1 at the edge position in the workpiece W illustrated in FIG. 4.

Then, the error detection unit 51 samples the edge position in the workpiece W at predetermined intervals of a rotation angle θ of the chuck spindle 21 on the basis of the edge trend line L1. The edge trend line L1 illustrated in FIG. 4 has its starting end corresponding to a rotation angle of 0 degrees of the chuck spindle 21 and has its terminating end corresponding to a rotation angle of 360 degrees of the chuck spindle 21. Therefore, the rotation angle θ of the chuck spindle 21 at any point can be calculated by measuring a distance between any point on the edge trend line L1 and the starting end of the edge trend line L1. The number of edge positions to be sampled can be optionally set in a range where arithmetic processing is not excessively complicated.

Then, the error detection unit 51 derives a coordinate function of the edge trend line L1 representing a relationship between a plurality of edge positions sampled thereby and the rotation angle of the chuck spindle 21. The coordinate function of the edge trend line L1 is expressed by Equation 1. In Equation 1, R is a radius of the workpiece W, and θ is a rotation angle of the chuck spindle 21 from a Y-axis.

$$\begin{matrix}[ Equation 1 ] & \\ edge ( θ ) = Δ r cos ( θ + Δω ) + \sqrt{{R}^{2} - Δ {r}^{2} {sin}^{2} ( θ + Δω )} & ( 1 )\end{matrix}$$

In Equation 1, assuming that Δr is significantly smaller than the radius R of the workpiece W, the second term in Equation 1 can approximate the constant R. When the coordinate function in Equation 1 is decomposed for each frequency by a fast Fourier transformation to exclude a constant component, the amplitude and the phase of a waveform that vibrates once while the chuck table 2 rotates once are obtained. In the fast Fourier transformation, it is known that, when the number of data is N, a time complexity O is N log N. The fast Fourier transformation is favorable in that arithmetic processing is not excessively complicated even when a sampling number at the edge position increases.

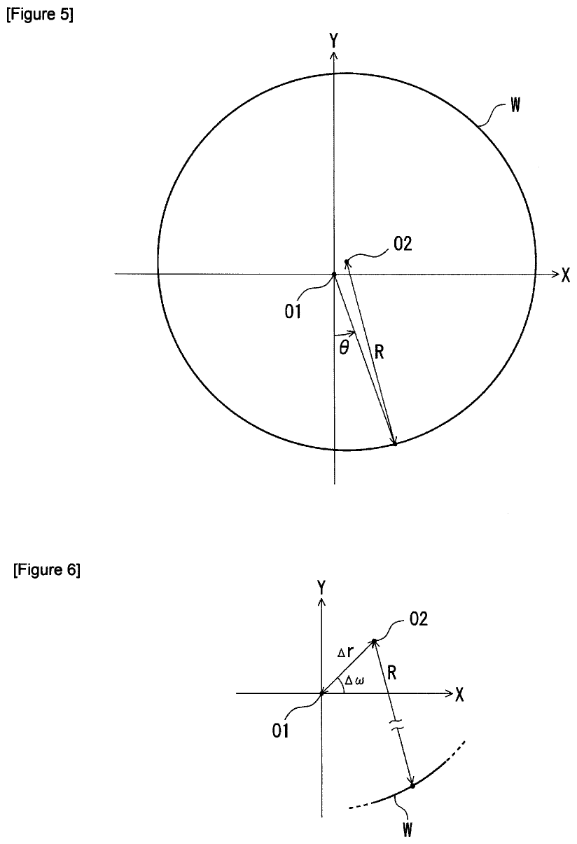

Here, as illustrated in FIGS. 5 and 6, a placement error between the rotation center 01 of the chuck table 2 and the center 02 of the workpiece W having a substantially central shape is composed of a distance Δr between the rotation center 01 of the chuck table 2 and the center 02 of the workpiece W and an angle (direction) Aw formed between a line segment connecting the rotation center 01 of the chuck table 2 and the center 02 of the workpiece W and an X-axis in an XY-coordinate system with the rotation center 01 of the chuck table 2 as an origin. The amplitude of the waveform that vibrates once while the chuck table 2 rotates once corresponds to the distance Δr, and the phase thereof corresponds to the direction Aw.

In this way, the amplitude and the phase of the waveform that vibrates once while the chuck table 2 rotates once, which are obtained by the fast Fourier transformation of the coordinate function of the edge trend line L1, respectively correspond to the placement errors Δr and Δw. Accordingly, a relative positional relationship between the chuck table 2 and the workpiece W can be simply detected without being affected by an outer diameter tolerance of the workpiece W. Imaging of the outer circumference of the workpiece W is not limited to that with the camera 4A, but may be that with either of the cameras 4B and 4C. A method for detecting the placement error of the workpiece W relative to the chuck table 2 is not limited to that described above.

### <Visual Inspection>

Then, the workpiece visual inspection apparatus 1 performs visual inspection for confirming whether or not a scratch, a crack, a fine particle, a surface burn, an abnormal streak, or the like exists on the processed surface Wa of the workpiece W.

### <Outer Circumference Inspection>

The determination unit 52 inspects the presence or absence of edge chipping or the like that tends to occur on the outer circumference of the workpiece W on the basis of the captured image I1 obtained by the imaging with the camera 4A.

For example, the determination unit 52 inspects the presence or absence of a defect such as edge chipping in the captured image I1 on the basis of a contrast ratio of the captured image I1 and determines the quality of the workpiece W on the outer circumference thereof. This makes it possible to perform outer circumference inspection of the workpiece W in parallel with the detection of the placement errors Δr and Δw.

The outer circumference inspection of the workpiece W to be performed in a short time in parallel with the detection of the placement errors Δr and Δω is included in inspection of the entire processed surface Wa of the workpiece W described below, and therefore is not necessarily essential in the visual inspection.

### <Entire Surface Inspection>

The determination unit 52 inspects the presence or absence of a defect such as a scratch, a crack, a fine particle, a surface burn, or an abnormal streak on the entire circumference of the workpiece W on the basis of a captured image that reflects the entire processed surface Wa imaged with the cameras 4A, 4B, and 4C, to perform entire surface inspection of the workpiece W.

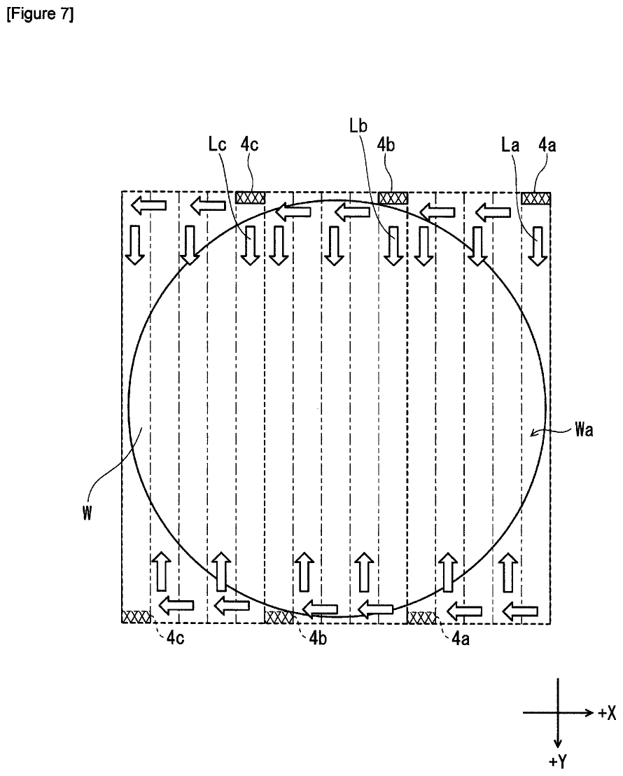

Specifically, the controller 5 first sets scanning paths La, Lb, and Lc that respectively scan the three cameras 4A, 4B, and 4C as illustrated in FIG. 7 in order for the cameras 4A, 4B, and 4C to image the entire processed surface Wa of the workpiece W in a shared manner on the basis of the placement errors Δr and Δω detected by the error detection unit 51.

The scanning paths La, Lb, and Lc illustrated in FIG. 7 are set in a rectangular shape as viewed from the top such that the imaging position 4a of the camera 4A, an imaging position 4b of the camera 4B, and an imaging position 4c of the camera 4C are movable without any space linearly along the X-axis or the Y-axis within three sections obtained by equally dividing a square including the processed surface Wa of the workpiece W. The respective sizes of the imaging positions 4b and 4c are set to, for example, about 2 μm×about 20 mm, similarly to that of the imaging position 4a.

Then, the first slide mechanism 23 and the second slide mechanism 44 are driven such that the imaging positions 4a, 4b, and 4c are respectively located at starting positions of the scanning paths La, Lb, and Lc, to move the cameras 4A, 4B, and 4C. In FIG. 7, each of the starting positions of the scanning paths La, Lb, Lc is set to a corner the X-coordinate and the Y-coordinate of which are respectively on the positive side and the negative side.

Then, when the first slide mechanism 23 is driven so that the chuck table 2 moves in a negative direction of the Y-axis, the cameras 4A, 4B, and 4C perform imaging every time the imaging positions 4a, 4b, and 4c move in a positive direction of the Y-axis by respective vertical dimensions of the imaging positions 4a, 4b, and 4c.

When the cameras 4A, 4B, and 4C respectively reach folding positions on the positive side of the Y-axis in the scanning paths La, Lb, and Lc, the second slide mechanism 44 is driven so that the camera stage 43 moves in a negative direction of the X-axis. As a result, the imaging positions 4a, 4b, and 4c move in the negative direction of the X-axis by respective width dimensions of the imaging positions 4a, 4b, and 4c.

Then, when the first slide mechanism 23 is driven so that the chuck table 2 moves in the positive direction of the Y-axis, the cameras 4A, 4B, and 4C perform imaging every time the imaging positions 4a, 4b, and 4c move in the negative direction of the Y-axis by the respective vertical dimensions of the imaging positions 4a, 4b, and 4c.

When the cameras 4A, 4B, and 4C respectively reach folding positions on the negative side of the Y-axis in the scanning paths La, Lb, and Lc, the second slide mechanism 44 is driven so that the camera stage 43 moves in the negative direction of the X-axis. As a result, the imaging positions 4a, 4b, and 4c move in the negative direction of the X-axis by the respective width dimensions of the imaging positions 4a, 4b, and 4c.

In the same manner, the imaging positions 4a, 4b, and 4c are respectively scanned in a rectangular shape up to ending positions indicated by broken lines in FIG. 7 along the scanning paths La, Lb, and Lc, thereby making it possible to obtain a plurality of continuous captured images including the entire processed surface Wa of the workpiece W. The first slide mechanism 23 moves at a constant speed during the imaging with the cameras 4A, 4B, and 4C, whereby an exposure time period can be kept constant, making it possible to image the entire surface of the workpiece W with uniform brightness.

Then, the determination unit 52 performs visual inspection of the entire surface of the workpiece W on the basis of the plurality of captured images that reflect the processed surface Wa imaged with the cameras 4A, 4B, and 4C.

For example, the determination unit 52 combines the plurality of captured images obtained by the imaging with the cameras 4A, 4B, and 4C into a single inspection image that reflects the processed surface Wa, inspects the presence or absence of a defect such as a scratch, a crack, a fine particle, a surface burn, or an abnormal streak on the entire circumference of the workpiece W on the basis of a contrast ratio of the inspection image, and determines the quality on the entire processed surface Wa of the workpiece W.

In visual inspection of, for example, a wafer (full-cut wafer) having a lattice-shaped dicing street formed thereon, a dicing-before-grinding wafer (half-cut wafer) having a groove formed thereon along the dicing street, or a ultrathin workpiece W having a circuit (street pattern) formed on its front surface is seen through, the determination unit 52 may erroneously determine the dicing street, the groove, or a street pattern (hereinafter collectively referred to as a “dicing street or the like”) as a crack, a scratch, or the like. Therefore, the determination unit 52 can perform mask processing for skipping inspection of the dicing street or the like.

The mask processing is used to specify a previously stored dicing street or the like that appears in an inspection image on the basis of the two-dimensional coordinates of the dicing street or the like and an angle (zero degrees or more and less than 90 degrees) of the dicing street or the like to the X-axis or the Y-axis and exclude the dicing street or the like from an inspection range in defect inspection. The angle of the dicing street or the like to the X-axis or Y-axis is an angle formed between a lattice-shaped dicing street or the like and the X-axis or the Y-axis as viewed from the top.

When a conventional inspection screen formed by combining a plurality of captured images obtained by imaging in a spiral shape is subjected to mask processing, the coordinates of a dicing street or the like need to be applied to the inspection screen after the two-dimensional coordinates of the dicing street or the like are converted into polar coordinates, resulting in a need to perform complicated image processing.

On the other hand, in the above-described workpiece visual inspection apparatus 1, the imaging positions 4a, 4b, and 4c move linearly along the X-axis or the Y-axis to perform imaging. Accordingly, the dicing street or the like in the inspection image can be easily specified, making it possible to perform accurate mask processing.

In this way, the above-described workpiece visual inspection apparatus 1 according to the present embodiment is a workpiece visual inspection apparatus 1 that determines the quality of a workpiece W after back surface processing, the workpiece visual inspection apparatus 1 being configured to include a chuck table 2 on which the workpiece W is placed, cameras 4A, 4B, and 4C that image a processed surface Wa of the workpiece W, a first slide mechanism 23 and a second slide mechanism 44 that move at least one of the chuck table 2 and the cameras 4A, 4B, and 4C relative to the other, to scan respective imaging positions 4a, 4b, and 4c of the cameras 4A, 4B, and 4C in a rectangular shape as viewed from the top, and a determination unit 52 that determines the quality of the workpiece W on the basis of the a plurality of captured images obtained by the imaging with the cameras 4A, 4B, and 4C.

This configuration makes it possible to accurately and efficiently determine the quality of the workpiece W because the respective imaging positions 4a, 4b, and 4c of the cameras 4A, 4B, and 4C are scanned in a rectangular shape relative to the workpiece W so that the processed surface Wa of the workpiece W is imaged.

In the workpiece visual inspection apparatus 1 according to the present embodiment, the first slide mechanism 23 and the second slide mechanism 44 are configured to move at least one of the chuck table 2 and the cameras 4A, 4B, and 4C such that the respective imaging positions 4a, 4b, and 4c of the cameras 4A, 4B, and 4C include the entire processed surface Wa.

This configuration makes it possible to accurately determine the quality of the workpiece W because the imaging positions 4a, 4b, and 4c are scanned to include the entire processed surface Wa.

In the workpiece visual inspection apparatus 1 according to the present embodiment, the cameras 4A, 4B, and 4C are configured to simultaneously image different ranges in the processed surface Wa.

The configuration makes it possible to efficiently perform visual inspection because the entire processed surface Wa can be imaged in a short time.

The workpiece visual inspection method according to the present embodiment is a workpiece visual inspection method for determining the quality of a workpiece W after back surface processing, the workpiece visual inspection method being configured to include a step of placing the workpiece W on a chuck table 2, a step of moving at least one of the chuck table 2 and cameras 4A, 4B, and 4C relative to the other, to scan respective imaging positions 4a, 4b, and 4c of the cameras 4A, 4B, and 4C in a rectangular shape as viewed from the top so that the cameras 4A, 4B, and 4C image a processed surface Wa of the workpiece W, and a step of determining the quality of the workpiece W on the basis of a plurality of captured images obtained by the imaging with the cameras 4A, 4B, and 4C.

This configuration makes it possible to accurately and efficiently determine the quality of the workpiece W because the respective imaging positions 4a, 4b, and 4c of the cameras 4A, 4B, and 4C are scanned in a rectangular shape relative to the workpiece W so that the processed surface Wa of the workpiece W is imaged.

In the present invention, it should be understood that various modifications can be made in addition to the foregoing without departing from the spirit of the prevent invention and the present invention covers the modifications.

Although a case where the quality of the workpiece W after grinding is determined has been described as an example in the above-described embodiment, the present invention is also applicable to a case where the quality of the workpiece W after polishing is determined.

For example, in the above-described embodiment, a case where the first slide mechanism 23 and the second slide mechanism 44 cooperate with each other to scan the respective imaging positions 4a, 4b, and 4c of the cameras 4A, 4B, and 4C has been illustrated as an example. However, when either one of the first slide mechanism 23 and the second slide mechanism 44 is configured to be able to scan the imaging positions 4a, 4b, and 4c along the X-axis or the Y-axis, the other may be omitted.

### REFERENCE SIGNS LIST

1: visual inspection apparatus
2: chuck table
21: chuck spindle
22: chuck stage
23: first slide mechanism (first driving mechanism)
3: base
31: column
4, 4A, 4B, 4C: camera (imaging unit)
4a, 4b, 4c: imaging position
41: line scan camera
42: collimator lens
43: camera stage
44: second slide mechanism (second driving mechanism)
5: controller
51: errors detection unit
52: determination unit
N: notch
O1: rotation center (of chuck table)
O2: center (of workpiece)
W: workpiece

1. A workpiece visual inspection apparatus that determines a quality of a workpiece after back surface processing, the workpiece visual inspection apparatus comprising:
a chuck table on which the workpiece is placed;
an imaging unit that images a processed surface of the workpiece;
a driving mechanism that moves at least one of the chuck table and the imaging unit relative to the other, to scan an imaging position of the imaging unit in a rectangular shape as viewed from the top; and
a determination unit that determines the quality of the workpiece on the basis of a plurality of captured images obtained by the imaging with the imaging unit.

2. The workpiece visual inspection apparatus according to claim 1, wherein:
the driving mechanism scans the imaging unit such that the imaging position of the imaging unit includes the entire processed surface.

3. The workpiece visual inspection apparatus according to claim 1, wherein the driving mechanism comprises:
a first driving mechanism that moves the chuck table in a first direction, and
a second driving mechanism that moves the imaging unit in a second direction perpendicular to the first direction.

4. The workpiece visual inspection apparatus according to claim 3, wherein:
the workpiece is placed on the chuck table with a lattice-shaped dicing street formed on the workpiece placed on the chuck table to be parallel to or inclined with respect to the first direction and the second direction.

5. The workpiece visual inspection apparatus according to claim 4, wherein:
the workpiece has a groove formed thereon along the dicing street.

6. The workpiece visual inspection apparatus according to claim 1, wherein:
the imaging unit comprises a plurality of imaging units, and
the plurality of imaging units simultaneously image different ranges in the processed surface.

7. A workpiece visual inspection method for determining a quality of a workpiece after back surface processing, the workpiece visual inspection method comprising the steps of:
placing the workpiece on a chuck table;
moving at least one of the chuck table and an imaging unit relative to the other, to scan an imaging position of the imaging unit in a rectangular shape as viewed from the top so that the imaging unit images a processed surface of the workpiece; and
determining the quality of the workpiece on the basis of a plurality of captured images obtained by the imaging with the imaging unit.
